(19) United States
(12) Patent Application Publication
(10) Pub. No.: US 2006/0227876 A1
(43) Pub. Date: Oct. 12, 2006

(54) System, method, and apparatus for AC coefficient prediction

(76) Inventors: Bhaskar Sherigar, Bangalore (IN); Anand Tongle, Bangalore (IN); Ramadas L. Pai, Bangalore (IN)

Correspondence Address: Christopher C. Winslade, Esq.;McANDREWS, HELD & MALLOY, LTD., 34th Floor, 500 West Madison Street, Chicago, IL, 60661, US

(21) Appl. No.: 11/092,932

(22) Filed: Mar. 29, 2005

(51) Int. Cl. H04N 11/04; H04N 7/12; H04B 1/66; H04N 11/02

(52) U.S. Cl. 375/240.18; 375/240.24

(57) ABSTRACT

Presented herein are system(s), method(s), and apparatus for AC coefficient prediction. In one embodiment, there is presented a method for predicting AC coefficients for a macroblock. The method comprises determining whether a particular block is predicted from a top neighboring block or a left neighboring block; retrieving from a buffer, data from the top neighboring block or left neighboring block from which the particular block is predicted; and writing data from the particular block to the buffer.

### RELATED APPLICATIONS

This application is related to “______”, application Ser. No. ______ (Attorney Docket No. 15910US01) filed ______ by Sherigar, et. al., which is incorporated herein by reference in its entirety for all purposes.

### FEDERALLY SPONSORED RESEARCH OR DEVELOPMENT

Not Applicable

### MICROFICHE/COPYRIGHT REFERENCE

Not Applicable

### BACKGROUND OF THE INVENTION

Various video compression standards, such as Advanced Video Coding (AVC) (also known as MPEG-4, Part 10, and ITU-H.264) use DC coefficient prediction to achieve greater compression. The video compression standards typically divide portions of pictures forming the video into blocks. Pixel data from the blocks is transformed to the frequency domain and represented by frequency coefficients.

The frequency coefficients include a DC coefficient and AC coefficients. The DC coefficient is not associated with a frequency or has a zero frequency. The AC coefficients are associated with various frequencies.

In AVC, the AC coefficients are predicted from the AC frequency coefficients of either a top neighboring block or a left neighboring block. The particular one of the top neighboring block or left neighboring block are determined by the DC coefficients of the top, left, and top left neighboring blocks.

During decoding, decoders typically decode macroblocks in raster order. Raster order begins with the top row of a picture, from left to right, proceeding to the next row downwards. While decoding the macroblocks, the decoder examines data from the top, left, and top left neighboring macroblocks.

Decoders typically include processors, or hardware accelerators, and bulk memory (typically DRAM). Generally, the DRAM is suitable for large amount of data storage and less frequent accesses. The processors and hardware accelerators utilize faster on-chip memory for storing small amount of data that is accessed frequently. The on-chip memory is more expensive and also consumes a great amount of area on the chip.

When the decoder decodes a macroblock, the macroblock may includes information that is used to decode the macroblock's bottom, and bottom right neighbors. However, the macroblock's bottom and bottom right neighbors will be decoded a full row later in the raster scan order. The foregoing uses a large amount of storage space to store the information from the macroblock from the time the macroblock is decoded until decoding it's bottom and bottom left neighbors.

Further limitations and disadvantages of convention and traditional approaches will become apparent to one of ordinary skill in the art through comparison of such systems with the present invention as set forth in the remainder of the present application with reference to the drawings.

### BRIEF SUMMARY OF THE INVENTION

Presented herein are system(s), method(s), and apparatus for AC coefficient prediction.

In one embodiment, there is presented a method for predicting AC coefficients for a block. The method comprises determining whether a particular block is predicted from a top neighboring block or a left neighboring block; retrieving from a buffer, data from the top neighboring block or left neighboring block from which the particular block is predicted; and writing data from the particular block to the buffer.

In another embodiment, there is presented a system for predicting AC coefficients for a block. The system comprises a first circuit, a top neighbor buffer, and a left neighbor buffer. The first circuit determines whether a particular block is predicted from a top neighboring block or a left neighboring block. The top neighbor buffer stores data from a top neighboring block. The left neighbor buffer stores data from a left neighboring block. The second circuit predicts AC coefficients for the particular block. The top neighbor buffer and the left neighbor buffer store data from the AC coefficients of the particular block.

In another embodiment, there is presented a circuit for predicting AC coefficients for block. The circuit comprises a first circuit, a top neighbor buffer, a left neighbor buffer, and a second circuit. The first circuit is operable to determine whether a particular block is predicted from a top neighboring block or a left neighboring block. The top neighbor buffer is connected to the circuit and operable to store data from a top neighboring block. The left neighbor buffer is connected to the circuit and operable to store data from a left neighboring block. The second circuit is connected to the first circuit and operable to predict AC coefficients for the particular block. The top neighbor buffer and the left neighbor buffer are operable to store data from the AC coefficients of the particular block.

These and other advantages and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram describing certain aspects of encoding in accordance with Advanced Video Coding;

FIG. 2 is a block diagram describing an exemplary video decoder in accordance with an embodiment of the present invention;

FIG. 3 is a block diagram of an inverse quantizer in accordance with an embodiment of the present invention;

FIG. 4 is a block diagram of buffers in accordance with an embodiment of the present invention;

FIG. 5 is a block diagram describing an AC predictor in accordance with an embodiment of the present invention;

FIG. 6 is a block diagram describing the buffer arrangement in accordance with an embodiment of the present invention.

FIG. 7 is a block diagram describing the DRAM interface in accordance with an embodiment of the current invention.

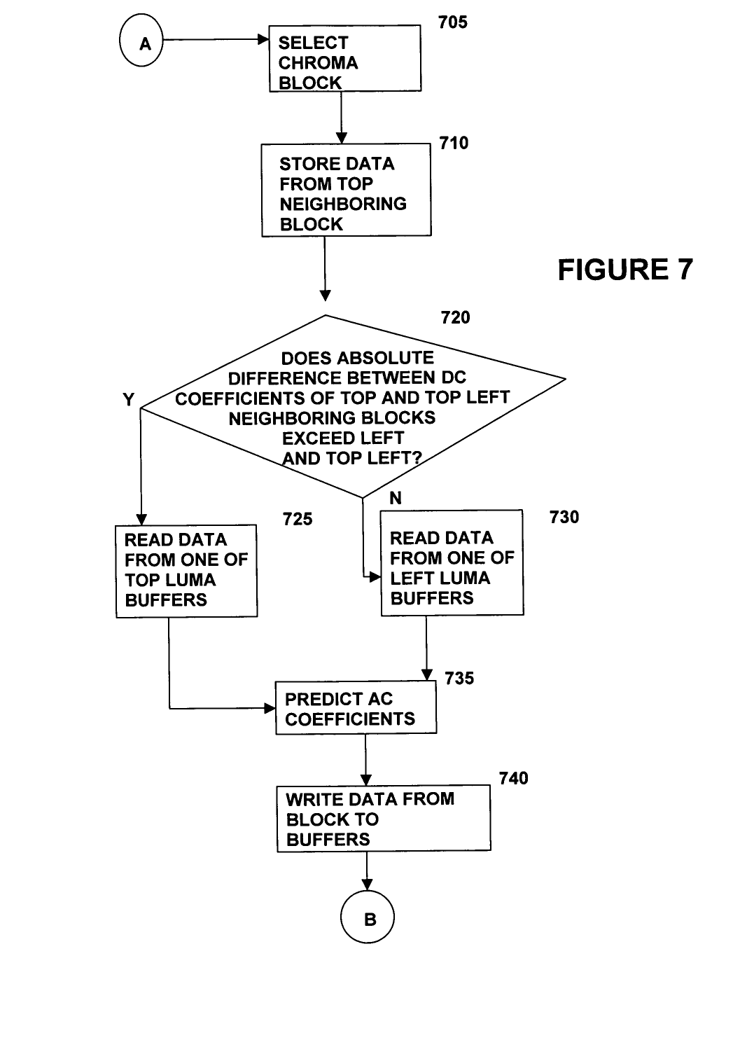

FIG. 8 is a flow diagram for decoding luma blocks in accordance with an embodiment of the present invention;

FIG. 9 is a flow diagram for decoding a chroma red block in accordance with an embodiment of the present invention; and

FIG. 10 is a flow diagram for decoding a chroma blue block in accordance with an embodiment of the present invention.

### DETAILED DESCRIPTION OF THE INVENTION

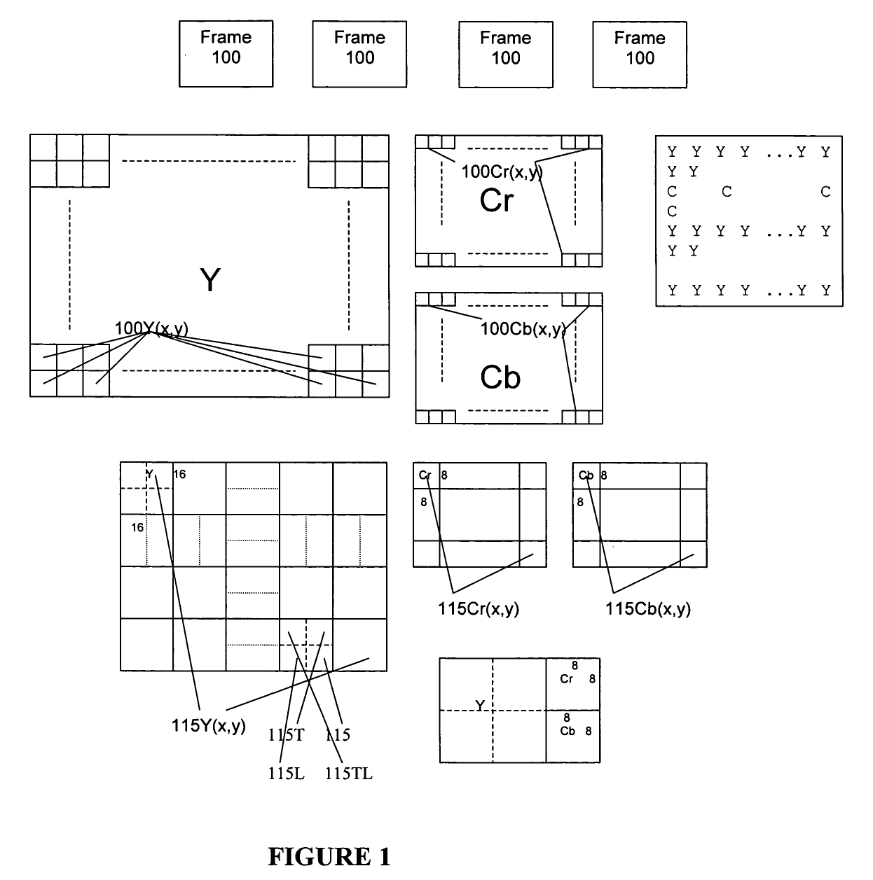

Referring now to FIG. 1, there is illustrated a block diagram of a picture 100. A video camera captures picture 100 from a field of view during time periods known as frame durations. The successive pictures 100 form a video sequence. A picture 100 comprises two-dimensional grid(s) of pixels 100(x,y).

For color video, each color component is associated with a two-dimensional grid of pixels. For example, a video can include a luma, chroma red, and chroma blue components. Accordingly, the luma, chroma red, and chroma blue components are associated with a two-dimensional grid of pixels 100Y(x,y), 100Cr(x,y), and 100Cb(x,y), respectively. When the grids of two dimensional pixels 100Y(x,y), 100Cr(x,y), and 100Cb(x,y) from the frame are overlayed on a display device 110, the result is a picture of the field of view at the frame duration that the frame was captured.

Generally, the human eye is more perceptive to the luma characteristics of video, compared to the chroma red and chroma blue characteristics. Accordingly, there are more pixels in the grid of luma pixels 100Y(x,y) compared to the grids of chroma red 100Cr(x,y) and chroma blue 100Cb(x,y). In the video standards having chroma format of 4:2:0, the grids of chroma red 100Cr(x,y) and chroma blue pixels 100Cb(x,y) have half as many pixels as the grid of luma pixels 100Y(x,y) in each direction.

The chroma red 100Cr(x,y) and chroma blue 100Cb(x,y) pixels are overlayed the luma pixels in each even-numbered column 100Y(x, 2y) between each even, one-half a pixel below each even-numbered line 100Y(2x, y). In other words, the chroma red and chroma blue pixels 100Cr(x,y) and 100Cb(x,y) are overlayed pixels 100Y(2x+½, 2y).

Luma pixels of the picture 100Y(x,y) can be divided into 8×8 pixel 100Y(8x−>8x+7, 8y−>8y+7) blocks 115Y(x,y). For four blocks of luma pixels 115Y(x,y), 115Y(x+1,y), 115Y(x, y+1), 115Y(x+1, y+1), there is a corresponding 8×8 block of chroma red pixels 115Cr(x,y) and chroma blue pixels 115Cb(x,y) comprising the chroma red and chroma blue pixels that are to be overlayed the block of luma pixels 115Y(x,y). A block of luma pixels 115Y(x,y), and the corresponding blocks of chroma red pixels 115Cr(x,y) and chroma blue pixels 115Cb(x,y) are collectively known as a macroblock 120. The macroblocks 120 can be grouped into groups known as slice groups 122.

Video Compression standards specify the use of spatial prediction, temporal prediction, and frequency transformations to reduce the amount of data for coding the blocks 115. Generally, the blocks 115 are represented as a residual difference, or prediction error, between the block 115 and another reference block 115. The prediction error itself corresponds to pixel values.

The prediction error is then transformed to the frequency domain and represented by frequency coefficients F₀₀ . . . F₇₇, in the case of an 8×8 block. The frequency coefficients include a DC coefficient F₀ and AC coefficients F₀₁ . . . F₇₇. To reduce the amount of data required to code each block 115, the AC frequency coefficients F₀₁ . . . F₇₇ are predicted either from first row of top block 115T or first column of left block 115L depending on the DC coefficients of the top 115T, left 115L, and top left 115TL neighboring block. The AC coefficients of block 115 are predicted from the one of the left 115L or top 115T neighboring blocks with the greatest absolute difference from the top left 115TL neighboring block.

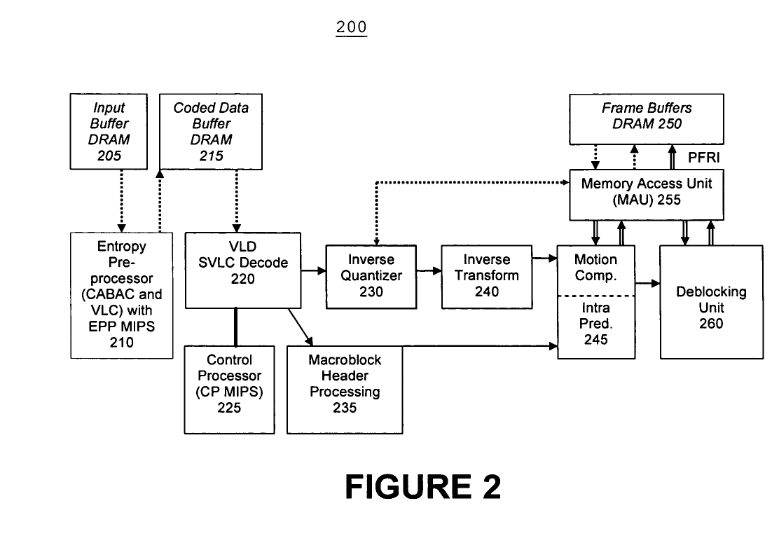

Referring now to FIG. 2, there is illustrated a block diagram describing an exemplary video decoder system 200 in accordance with an embodiment of the present invention. The video decoder 200 comprises an input buffer DRAM 205, an entropy pre-processor 210, a coded data buffer DRAM 215, a variable length code decoder 220, a control processor 225, an inverse quantizer 230, a macroblock header processor 235, an inverse transformer 240, a motion compensator and intrapicture predictor 245, frame buffers 250, a memory access unit 255, and a deblocker 260.

The input buffer DRAM 205, entropy pre-processor 210, coded data buffer DRAM 215, and variable length code decoder 220 together decode the variable length coding associated with the video data, resulting in pictures 100 represented by macroblocks 120.

The inverse quantizer 230 predicts the top row or the left column of the blocks of quantized frequency coefficients and inverse quantizes. The macroblock header processor 235 examines side information, such as parameters that are encoded with the macroblocks 120.

The inverse transformer 240 transforms the blocks of frequency coefficients F₀ . . . Fₙ, thereby resulting in the prediction error PE. The motion compensator and intrapicture predictor 245 decodes the macroblock 120 pixels from the prediction error PE. The decoded macroblocks 120 are stored in frame buffers 250 using the memory access unit 255. A deblocker 260 is used to smooth the edges of adjacent macroblocks 120.

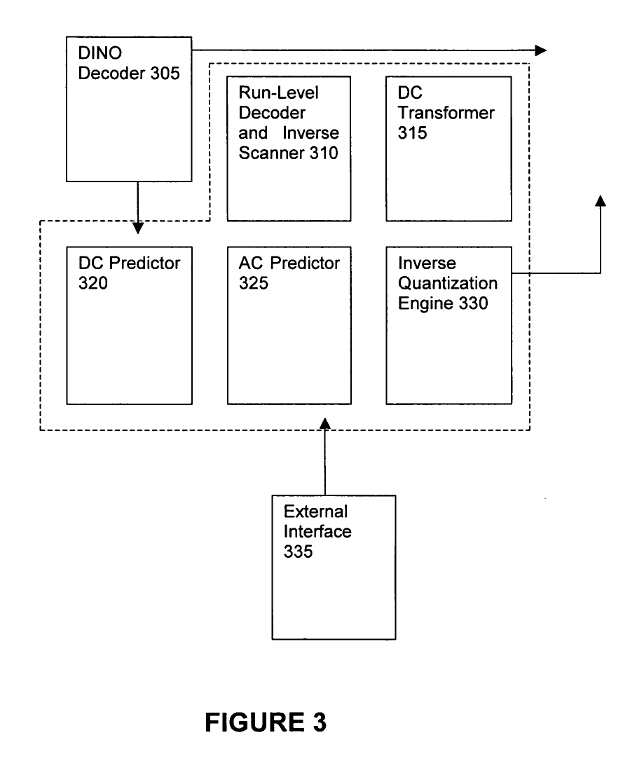

Referring now to FIG. 3, there is illustrated a block diagram describing an exemplary inverse quantizer 230 in accordance with an embodiment of the present invention. The inverse quantizer 230 comprises a data input and output—DINO Decoder 305, a run level decoder and inverse scanner 310, a DC transformer 315, a DC predicter 320, an AC predictor 325, an inverse quantization engine 330, external interfaces 335, and a DINO encoder 340.

The external interfaces 335 initialize the inverse quantizer 230 at every picture header level with the parameters. The run-level decode and inverse scanner 310 does the “zero filling” operation decided by the run count of run pairs and inverse scans by providing a correct address of a buffer based on a look-up table.

AC and DC prediction can be used in certain standards such as AVC and VC9. Where DC prediction is enabled, the DC predictor 320 performs the DC prediction functions and provides the results to the AC predictor 325. Where AC prediction is enabled, the AC predictor performs 325 the AC prediction functions. The DC predictor 320 and DC prediction can comprise, for example, the system(s), method(s), and apparatus described in ______, Ser. No. ______, filed by Sherigar, et. al., and incorporated herein by reference.

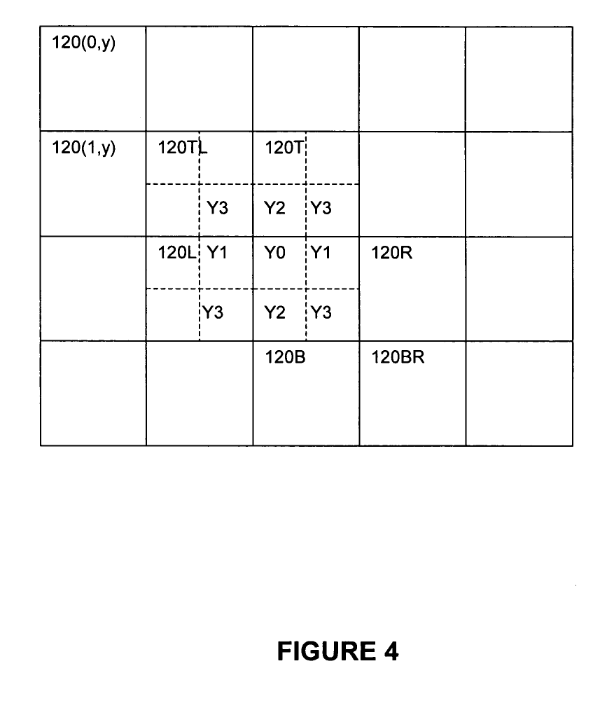

Referring now to FIG. 4, there is illustrated a block diagram describing decoded macroblocks 120 in accordance with an embodiment of the present invention. The video decoder 200 decodes the macroblocks 120 in raster order. In raster order, the first row of macroblocks 120(0,y) is decoded from left to right, proceeding to the next row 120(1,y), and downwards. The blocks 115 are represented by AC coefficients F₁ . . . Fₙ, and DC coefficients F₀. The AC coefficients of first row or first column, are predicted from the respective AC coefficients of either the top neighboring block 115T, or the left neighboring block 115L.

It is noted that in a macroblock 120 comprising four luma blocks 115Y, the top and left neighboring blocks for the top left block Y0 are located in the top 120T and left 120L neighboring macroblocks. The top neighboring block for the top right block Y1 is located in the top 120T neighboring macroblocks. The left neighboring block for the bottom left block Y2 is located in the left 120L neighboring macroblock. Additionally, the blocks Y1, Y2, and Y3 are neighboring blocks for blocks in the right 120R, bottom 120B, and bottom right 120BR, neighboring macroblocks 120.

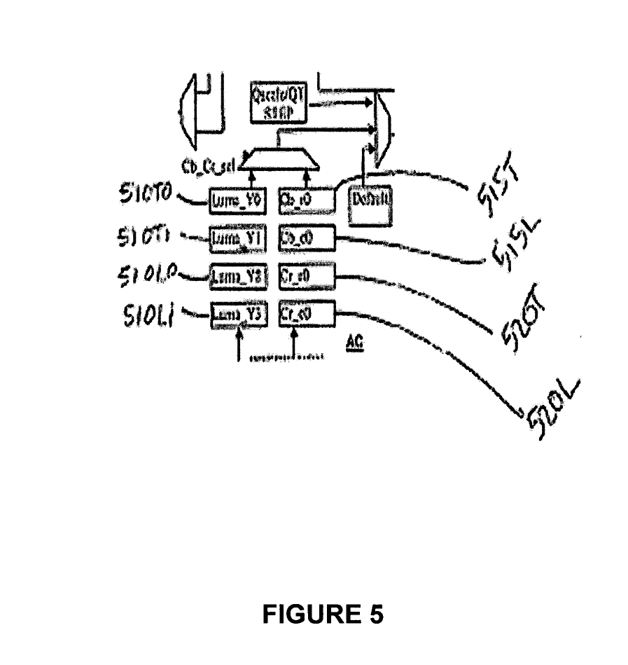

Referring now to FIG. 5, there is illustrated a block diagram describing the AC predictor 325 in accordance with an embodiment of the present invention. The AC predictor 325 comprises luma buffers 510, chroma red buffers 515, and chroma blue buffers 520. The luma buffers 510 comprise first and second top and left neighbor buffers 510T0, 510T1, 510L0, and 510L1. The chroma red buffers comprise top and left neighbor buffers 515T, 515L. The chroma blue buffers 520 comprise top and left neighbor buffers 520T, 520L.

The foregoing buffers store data from top 115T and left 115L neighboring blocks. The AC predictor 325 retrieves the data and predicts the AC frequency coefficients , for a block 115 there from. The AC predictor 325 determines whether a particular block 115 is predicted from its top neighbor 115T or left neighbor 115L by examining the DC coefficients of the top neighbor 115T, left neighbor 115L, and top left neighbor 115TL. The DC coefficients are provided by the DC predictor 320. The AC coefficients are predicted from the neighboring block 115L or 115T with the DC coefficient with the greatest absolute difference between itself and the DC coefficient of the top left neighbor 115TL. The AC predictor 325 determines the foregoing and the particular one of the buffers 510, 515, 520 that store the data from the appropriate neighboring block.

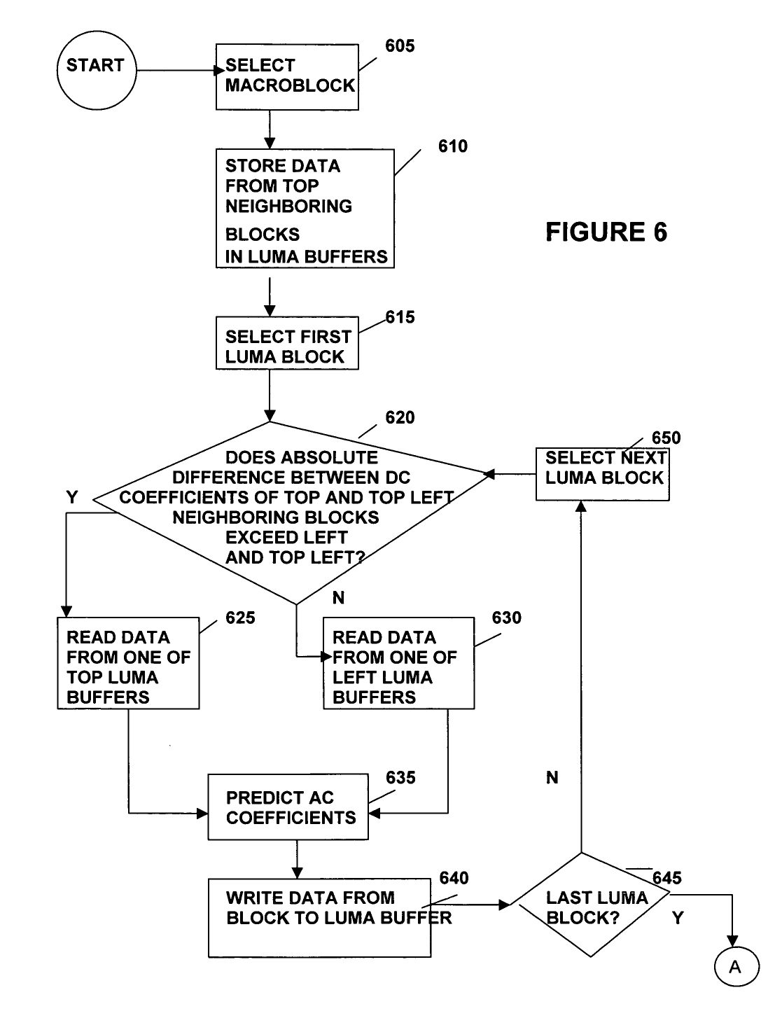

Referring now to FIG. 6, there is illustrated a block diagram describing an exemplary buffer management scheme for an AC predictor 325 in accordance with an embodiment of the present invention. There exist four luma buffers 905 corresponding to luma blocks Y0, Y1, Y2 and Y3, two chroma red 910 buffers, and two chroma blue 915 buffers respectively for a macroblock 120. Each buffer mentioned above contains the storage space for 7 pixels, corresponding to either first row or the first column of the block. Luma block Y0 predicts from either top_{—}0 buffer or left_{—}0 buffer depending on the prediction direction calculated and provided by DC predictor. Upon completing the prediction for Y0 in 905, the result of the newly constructed row or column will be written into the buffer from where the prediction has been performed. Above mentioned sequence continues for the remaining luma blocks Y1, Y2 and Y3. At the end of prediction for Y3, left_{—}0 and left_{—}1 buffers contain the prediction values to be used in future in the neighboring macroblock 120R.

Chroma red block Cr0 predicts from either top_{—}0 buffer or left_{—}0 buffer depending on the prediction direction calculated and provided by DC predictor. Upon completing the prediction for Cr0, the result of the newly constructed row or column will be written into the buffer from where the prediction has been performed. Above-mentioned sequence continues for the remaining chroma blue block Cb0. At the end of prediction for Cb0 of macroblock 120, left_{—}0 and left_{—}1 buffers contain the chroma red and chroma blue prediction values to be used in future in the neighboring macroblock 120R. The foregoing sequence of buffer selection for prediction read and prediction write back for various blocks of luma, chroma red and chroma blue are listed in the tables 920 and 925.

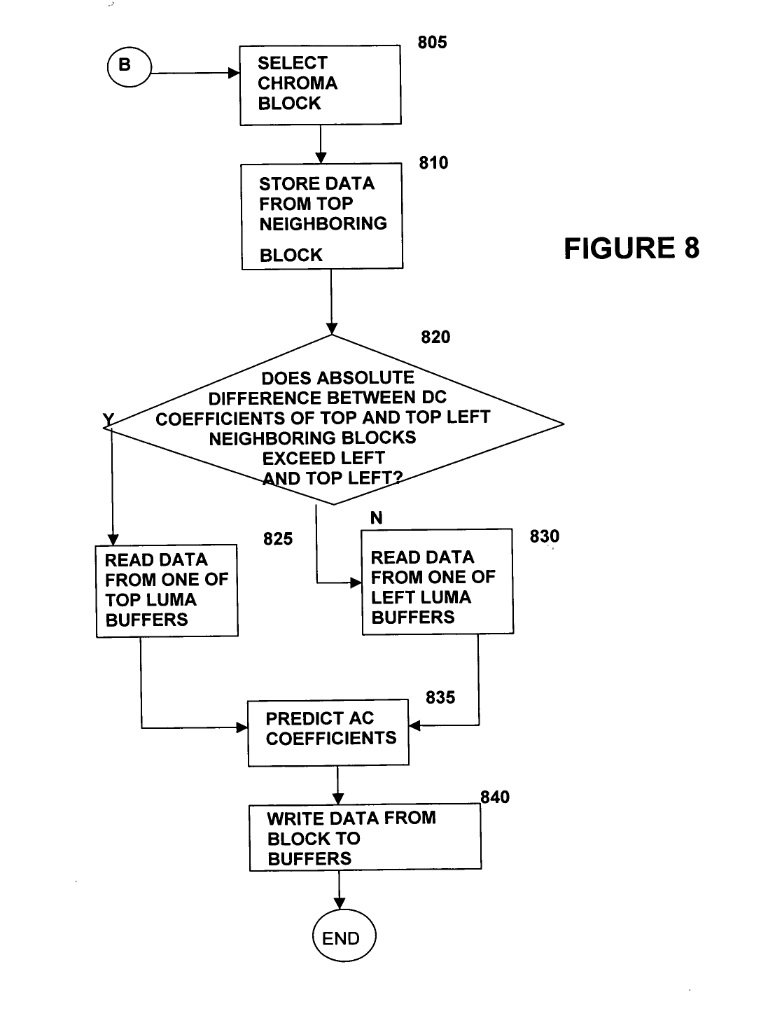

Referring now to FIG. 8, there is illustrated a block diagram describing the buffer management for DRAM access scheme for AC predictor 325 in accordance with an embodiment of the present invention. A section of an exemplary frame 100 is shown with various mabroblocks 1005 with numbers MB0 to MB7 in 1015. There is presented a double buffer scheme to access DRAM. During the decoding of macroblock MB3, which is the last macroblock of a row of macroblocks, prediction values for MB4 are fetched from DRAM. This is used to meet the performance budget of the block, so that the prediction data of macroblock 120T, i.e top rows of pixels of macroblock MB0, are available at the beginning of the decode of macroblock MB4. A DRAM read request 1020 is issued during the decode of MB3, and a DRAM write request 1025 for the computed prediction values is issued at the end of the decode of macroblock MB3. Top buffers of macroblock 120T for luma, chroma red and chroma blue are arranged in a double buffer scheme 1010, where one part of the double buffer is owned by AC predictor and other part by the DRAM managed by DRAM buffer manager. The buffers owned by AC predictor contains the prediction values read from DRAM and over-written by the new values being calculated, wherein the other part of the double buffer contains the prediction values to be written to DRAM which may be used in future when the next row of macroblocks being decoded. The sequence of read 1020 and write 1025 accesses and blocks under decode 1030 for luma, chroma red and chroma blue are repeated for each macroblock.

Referring now to FIG. 8, there is illustrated a flow diagram for decoding a macroblock 120 in accordance with an embodiment of the present invention. At 605, a macroblock 120 is selected for decoding. Initially, luma buffer 510L0 stores data from block 115Y1 of the left neighboring macroblock 120L, and buffer 510L1 stores data from block 115Y3 of the left neighboring macroblock 120L. At 610, data from blocks Y2 and Y3 from the top neighboring macroblock 120T are stored in luma buffers 510T0 and 510T1 respectively.

| LUMA | Top | Left | Top Left | Write | Read |
|---|---|---|---|---|---|
| BLOCK | Neighbor | Neighbor | Neighbor | Buffer | Buffer |
| Y0 | Y2 in 120T | Y1 in 120L | Y3 in | 510L(0) | 510L(0) or |
| | | | 120TL | 510T(0) | 510T(0) |
| Y1 | Y3 in 120T | Y0 | Y2 in | 510L(0) | 510L(0) or |
| | | | 120T | 510T(1) | 510T(1) |
| Y2 | Y0 | Y3 in 120L | Y1 in | 510L(1) | 510L(1) or |
| | | | 120L | 510T(0) | 510T(0) |
| Y3 | Y1 | Y2 | Y0 | 510L(1) | 510L(1) or |
| | | | | 510T(1) | 510T(1) |

The above table will now be referenced. At 615, the first of the luma blocks Y0 in the macroblock 120 is selected for AC frequency coefficient prediction. At 620, the DC frequency coefficients (provided by the DC predictor 320) from the top, left, and top left neighboring blocks 115 are examined and a determination is made whether the absolute distance is greater between the top neighbor and the top left neighbor, or the left neighbor and the top left neighbor.

If absolute difference between DC coefficients of the top neighbor and the top left neighbor is greater than the DC coefficients between the left neighbor and the top left neighbor, then the AC predictor 325 reads data from the top luma buffer 510T indicated in the table above at 625. Otherwise, the AC predictor 325 reads data from the left luma buffer 510L indicated in the table above at 630.

At 635, the AC predictor 325 predicts the AC coefficients for the luma block. At 640, the AC predictor 325 writes data from the luma block to the luma buffers 510 indicated in the table above. At 645, a determination is made whether the last luma block Y3 of the macroblock 120 is predicted. If the last luma block Y3 of the macroblock is not predicted, at 650, the next luma block in the macroblock 120 is selected, and 620 is repeated.

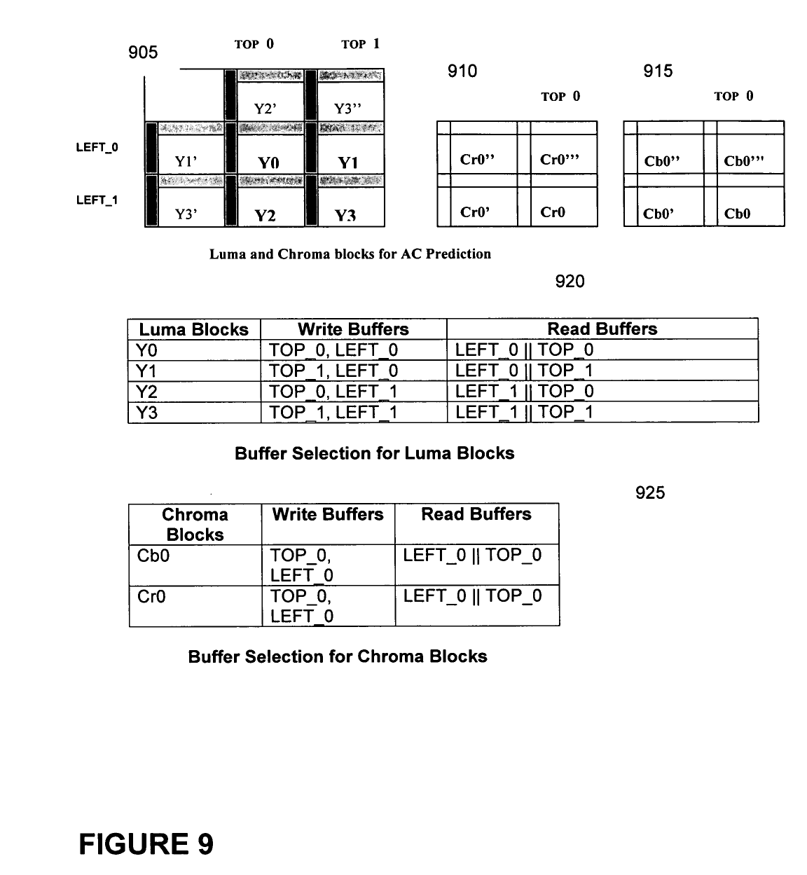

If the last luma block Y3 of the macroblock is repeated during 645, at 705 (turning now to FIG. 9) the chroma red block of the macroblock 120 is selected. Initially, data from the left neighboring chroma red block (the chroma red block of the left neighboring macroblock 120L) is stored in the chroma red buffer 515L. At 710 data from the top neighboring chroma red block (the chroma red block of macroblock 120T) is stored chroma red buffer 510T and 510T1 respectively.

At 720, the DC frequency coefficients (provided by the DC predictor 320) from the top, left, and top left neighboring blocks 115 are examined and a determination is made whether the absolute distance is greater between the top neighbor and the top left neighbor, or the left neighbor and the top left neighbor.

If absolute difference between DC coefficients of the top neighbor and the top left neighbor is greater than the DC coefficients between the left neighbor and the top left neighbor, then the AC predictor 325 reads data from the top buffer 515T at 725. Otherwise, the AC predictor 325 reads data from the left buffer 515L at 730.

At 735, the AC predictor 325 predicts the AC coefficients for the chroma red block. At 740, the AC predictor 325 writes data from the chroma red block to the chroma red buffers 515.

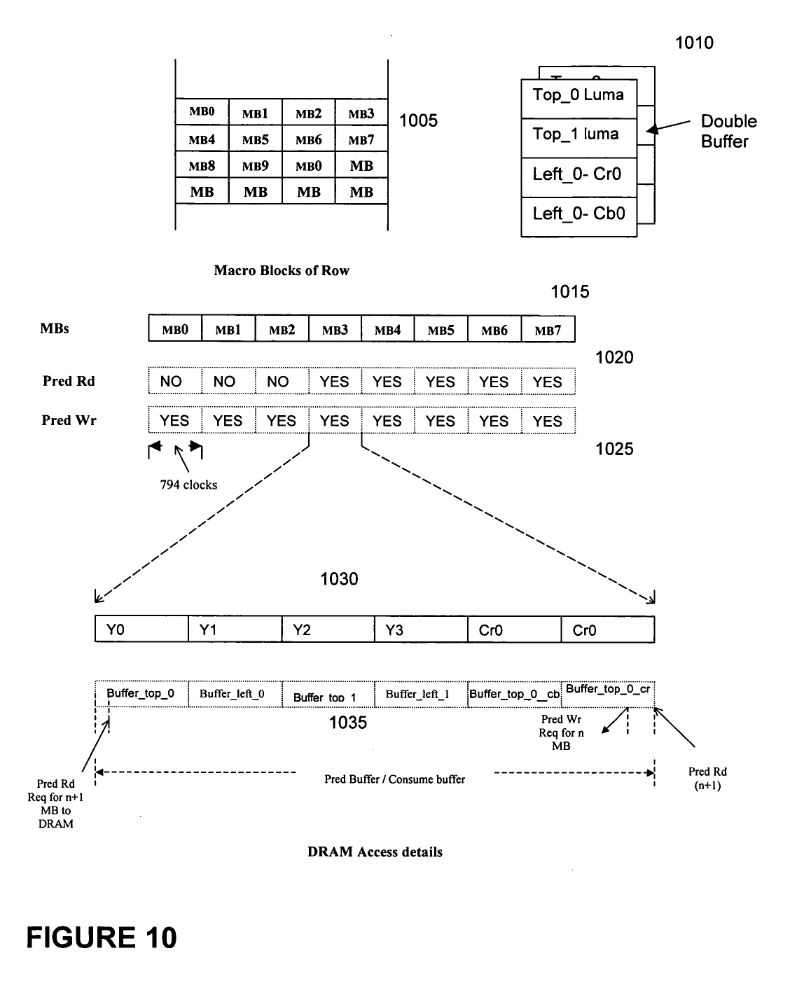

Referring now to FIG. 10, at 805 the chroma blue block of the macroblock 120 is selected. Initially, data from the left neighboring chroma blue block (the chroma blue block of the left neighboring macroblock 120L) is stoblue in the chroma blue buffer 520L. At 810 data from the top neighboring chroma blue block (the chroma blue block of macroblock 120T) is stoblue chroma blue buffer 510T and 510T1 respectively.

At 820, the DC frequency coefficients (provided by the DC pblueictor 320) from the top, left, and top left neighboring blocks 115 are examined and a determination is made whether the absolute distance is greater between the top neighbor and the top left neighbor, or the left neighbor and the top left neighbor.

If an absolute difference between DC coefficients of the top neighbor and the top left neighbor is greater than the DC coefficients between the left neighbor and the top left neighbor, then the AC predictor 325 reads data from the top buffer 520T at 825. Otherwise, the AC predictor 325 reads data from the left buffer 520L at 830.

At 835, the AC predictor 325 pblueicts the AC coefficients for the chroma blue block. At 840, the AC pblueictor 325 writes data from the chroma blue block to the chroma blue buffers 520.

The degree of integration of the system may primarily be determined by speed and cost considerations. Because of the sophisticated nature of modern processor, it is possible to utilize a commercially available processor, which may be implemented external to an ASIC implementation. If the processor is available as an ASIC core or logic block, then the commercially available processor can be implemented as part of an ASIC device wherein certain functions can be implemented in firmware. In one embodiment, the foregoing can be integrated into an integrated circuit. Additionally, the functions can be implemented as hardware accelerator units controlled by the processor.

While the invention has been described with reference to certain embodiments, it will be understood by those skilled in the art that various changes may be made and equivalents may be substituted without departing from the scope of the invention. In addition, many modifications may be made to adapt particular situation or material to the teachings of the invention without departing from its scope. Therefore, it is intended that the invention not be limited to the particular embodiment(s) disclosed, but that the invention will include all embodiments falling within the scope of the appended claims.

1. A method for predicting AC coefficients for a macroblock, said method comprising:
determining whether a particular block is predicted from a top neighboring block or a left neighboring block;
retrieving from a buffer, data from the top neighboring block or left neighboring block from which the particular block is predicted; and
writing data from the particular block to the buffer.

2. The method of claim 1, wherein determining whether the particular block is predicted from the top neighboring block or the left neighboring block further comprises:
determining an absolute difference between a DC coefficient associated with the top neighboring block and a DC coefficient associated with a top left neighboring block; and
determining an absolute difference between a DC coefficient associated with the left neighboring block and a DC coefficient associated with a top left neighboring block.

3. The method of claim 1, wherein writing the data from the particular block further comprises overwriting the data from the top neighboring block or left neighboring block from which the particular block is predicted.

4. The method of claim 1, wherein writing the data from the particular block further comprises overwriting the data from the top neighboring block and the left neighboring block.

5. The method of claim 1, wherein retrieving from a buffer further comprises:
determining a particular buffer from a plurality of buffers, the particular buffer storing the data from the top neighboring block or left neighboring block from which the particular block is predicted.

6. The method of claim 1, further comprising:
writing data from the top neighboring block to one of a plurality of buffers, said plurality of buffers comprising the buffer.

7. A system for predicting AC coefficients for a macroblock, said system comprising:
a first circuit for determining whether a particular block is predicted from a top neighboring block or a left neighboring block;
a top neighbor buffer for storing data from a top neighboring block;
a left neighbor buffer for storing data from a left neighboring block;
a second circuit for predicting AC coefficients for the particular block; and
wherein the top neighbor buffer and the left neighbor buffer store data from the AC coefficients of the particular block.

8. The system of claim 7, wherein determining whether the particular block is predicted from the top neighboring block or the left neighboring block further comprises:
determining an absolute difference between a DC coefficient associated with the top neighboring block and a DC coefficient associated with a top left neighboring block; and
determining an absolute difference between a DC coefficient associated with the left neighboring block and a DC coefficient associated with a top left neighboring block.

9. The system of claim 7, wherein storing the data from the particular block further comprises overwriting the data from the top neighboring block and the left neighboring block.

10. A circuit for predicting AC coefficients for a macroblock, said circuit comprising:
a first circuit operable to determine whether a particular block is predicted from a top neighboring block or a left neighboring block;
a top neighbor buffer connected to the circuit and operable to store data from a top neighboring block;
a left neighbor buffer connected to the circuit and operable to store data from a left neighboring block;
a second circuit connected to the first circuit and operable to predict AC coefficients for the particular block; and
wherein the top neighbor buffer and the left neighbor buffer are operable to store data from the AC coefficients of the particular block.

11. The circuit of claim 10, wherein determining whether the particular block is predicted from the top neighboring block or the left neighboring block further comprises:
determining an absolute difference between a DC coefficient associated with the top neighboring block and a DC coefficient associated with a top left neighboring block; and
determining an absolute difference between a DC coefficient associated with the left neighboring block and a DC coefficient associated with a top left neighboring block.

12. The circuit of claim 10, wherein storing the data from the particular block further comprises overwriting the data from the top neighboring block and the left neighboring block.
